(19) United States
(12) Patent Application Publication
(10) Pub. No.: US 2014/0350696 A1
(43) Pub. Date: Nov. 27, 2014

(54) ILG

(71) Applicant: Alfred M. Haas, Oakhurst, NJ (US)

(72) Inventor: Alfred M. Haas, Oakhurst, NJ (US)

(21) Appl. No.: 14/215,226

(22) Filed: Mar. 17, 2014

Related U.S. Application Data
(60) Provisional application No. 61/791,063, filed on Mar. 15, 2013.

(51) Int. Cl. G05B 15/02

(52) U.S. Cl. CPC G05B 15/02
USPC 700/11; 700/1; 700/28

(57) ABSTRACT

The instant invention is related to methods and means for interacting with and controlling and/or regulating things—from appliances to environments, from potential mates to proprietors, and just about everything in between. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS:

Pursuant to 35 USC §119(e) and as set forth in the Application Data Sheet, this utility application claims the benefit of priority from U.S. Provisional Patent Application No. 61/791,063 (“the '063 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '063 provisional and expressly incorporates by reference the disclosures contained therein in their entirety, including but not limited to all patents, patent applications, and publications which are incorporated by reference in the '063 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system. Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: computers, smart phones, PDAs, other commercially available electronic devices such as tablet PCs, netbooks, e-readers (e.g., Kindle™ and Nook™), pagers, alarms, beepers, cell phones, hearing aids, watches comprising integrated and/or discrete circuits, monitors and displays, televisions, calculators, iPods™ and MP3 players, speakers, microphones, radios and stereos, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, DSPs, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, radio frequency identification (“RFID”) devices, near-field communication (“NFC”) devices, coils, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, and other circuits and systems comprised of circuits.

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, and other aspects of some embodiments of the disclosed invention—including, but not limited to software and hardware such as sensors and transducers, circuits, transmitters, receivers, housings, wearable and other mobile devices, programmable logic elements and chips, custom ASICs, electrical and mechanical switches, electrical and mechanical regulators, etc. Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Elements of Information Theory, by Thomas M. Cover and Joy A. Thomas, published by Willey Interscience, copyright 1991; Information Theory and Reliable Communication, by Robert G. Gallager, published by John Wiley and Sons, copyright 1968; Principles of Communication Engineering, by John M. Wozencraft and Irwin Mark Jacobs, published by Waveland Press, copyright 1965; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; Programming in Objective-C, Fifth Edition by Stephen G. Kochan, published by Addison-Wesley, copyright 2103; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The instant invention is related to methods and means for interacting with and controlling and/or regulating things—from appliances to environments, from potential mates to proprietors, and just about everything in between.

### BRIEF DESCRIPTION OF THE SEVERAL VIEWS OF THE DRAWINGS

FIGS. 1-20 illustrate some specific examples of prototypes of embodiments of the instant invention.

FIG. 1 illustrates a 3D schematic of an example of an element of an embodiment of a smart band for housing a power supply (a battery).

FIG. 2 illustrates a 3D schematic of an example of another element of an embodiment of a smart band, comprising a rigid band onto which a mounting surface comprising a microcontroller, a communications module and a power supply may be affixed.

FIG. 3 shows a 3D schematic of an example of another element of an embodiment of a smart band, comprising a cover for a power supply and a mounting surface for affixing a microcontroller and a communications module.

FIGS. 4 and 5 respectively represent 3D schematics of an example of an embodiment of a housing and a housing cover for a sensor module.

FIG. 6 illustrates a 3D schematic of an example of a mounting surface element of an embodiment of a smart ring, onto which a processing unit, a communications module and a power supply may be affixed.

FIG. 7 illustrates a 3D schematic of an example of another element of an embodiment of a smart ring, comprising a rigid ring onto which a mounting surface comprising a communications module and a power supply may be affixed.

FIG. 8 illustrates a 3D schematic of an example of a mounting surface element of an embodiment of a smart ring, onto which a processing unit, a communications module and a power supply may be affixed.

FIG. 9 illustrates an assembled example of a prototype of an embodiment of a smart band, comprising a rigid band onto which a mounting surface comprising a microcontroller, a communications module and a power supply is affixed.

FIG. 10 illustrates an assembled example of a prototype of an embodiment of a smart ring, comprising a rigid band onto which a mounting surface comprising a pair of dummy circuits has been affixed.

FIGS. 11-17 illustrate 3D schematics of the components comprising the housing of an example of an embodiment of a smart band.

FIGS. 11 and 12 illustrate 3D schematics of two different examples of an element of an embodiment of a smart band, comprising a rigid base onto which a power supply and a mounting surface comprising a microcontroller, a communications module and an accelerometer may be affixed.

FIGS. 13-17 illustrate 3D schematics of several different components of another element of an embodiment of a smart band, comprising mounting surfaces for a microcontroller, communications module, and accelerometer, and a cover for a power supply.

FIGS. 13 and 14 illustrate respective views of a top and a bottom of a component of an embodiment, the top illustrated in FIG. 13 comprising a mounting surface and the bottom illustrated in FIG. 14 comprising a surface and a portion of a cover.

FIG. 15 illustrates a view of two components of an embodiment, the left component in the figure comprising a mounting bracket and the right comprising a surface and a portion of a cover.

FIG. 16 illustrates a component of an embodiment comprising a surface and a portion of a cover.

FIG. 17 illustrates a component of an embodiment comprising a mounting bracket.

FIG. 18 illustrates an assembled example of a prototype of an embodiment of a smart sensor, comprising a sensor module, a microcontroller and a housing.

FIGS. 19-20 illustrate partially assembled examples of prototypes of embodiments of a smart device, comprising a rigid base, a microcontroller, a communications module, an accelerometer, a vibrating transduction element, and a power supply.

### DETAILED DESCRIPTION OF THE INVENTION

The instant invention is directed to methods and means for interacting with and controlling and/or regulating things. Some embodiments of the methods and means of the invention incorporate functionality including, but not limited to communication, sensing, display and data processing elements.

Some embodiments of the invention comprise “smart switches.” In some embodiments, smart switches comprise digital switches, for example including but not limited to on/off and multilevel switches. In some embodiments smart switches comprise analog switches or regulators, for example including but not limited to gas flow and current regulators. In some embodiments smart switches comprise some combination of analog and digital switching elements, for example including but not limited to event triggered proportional controllers like some thermostats according to some embodiments of the instant invention. One specific example of an embodiment of a smart switch comprises an automatic wall switch that may be set to turn on and/or off according to the satisfaction of one or more conditions, including but not limited to the occurrence of an event. In some embodiments, a wall switch comprises a socket enclosure and a relay; in some embodiments a wall switch comprises an electrical outlet and a relay. In some embodiments, a relay comprises discrete components; in some embodiments, a relay comprises solid state devices; in some embodiments a relay comprises a combination of discrete and solid state elements. In some embodiments, an RF transceiver comprises a Bluetooth module; in some embodiments an RF transceiver comprises a WiFi module; in some embodiments, an RF transceiver comprises a proprietary, commercially available module, for example one of TI's™ sub-1 GHz CC 1000 family chips or a proprietary 2.4 GHz module such as the CC2500 family of RF transceivers. These are illustrative examples and not intended to limit the invention—transceivers according to some embodiments of the invention may be manufactured by other companies than TI™, employ other frequencies (as permitted by law) than the bands enumerated above, and may comprise custom circuits fabricated to spec by a foundry. In some embodiments of the invention, communications modules comprise an RF transceiver and an antenna. According to some embodiments of the invention, an antenna comprises an integrated antenna; in some embodiments an antenna comprises a wire; in some embodiments an antenna comprises a conductive polymer.

Some embodiments of the invention comprise methods and means for regulating appliances, devices and other apparatuses, including, but not limited to, switching off or regulating: the current and/or voltage supplied to an appliance, device or other apparatus, the light, heat or other electromagnetic radiation (e.g. UV, microwaves) emitted by a source, the flow of fluids such as water, natural gas, or gasoline to or from a system comprising an appliance device, or other apparatus (e.g. the flow of water to a shower, or the flow of gas to an oven), under certain conditions. One specific example of an embodiment comprises a wall switch—used in this specific example to regulate an electric stove—with an RF transceiver that reads the proximity of another transceiver a user's bracelet and: (a) won't let a user turn on the stove until she's within a certain programmable distance from it; and (b) will turn the stove off if she leaves the vicinity (exceeds a certain distance from the appliance) for a programmable period of time.

In some embodiments, proximity between a user and an appliance, device, or other apparatus may be deduced from the RF signal strength between a transceiver on a smart band, ring or other device and a second transceiver associated with the appliance, device or other apparatus, including a smart switch. In one example of an embodiment of the invention, a transceiver associated with a switch, appliance, device, or other apparatus can periodically “ping” a device, such as an RFID device worn by the individual, for example in a band, ring or other accessory or small piece of apparel, and the transceiver may engage the device worn by the individual to detect the proximity of the wearer to the switch. In some embodiments, a worn device may be an active device such as a transceiver; in some embodiments a worn device may be a passive device. In some embodiments, the device worn by or associated with a user may be a passive device such as an alloy of metal, a coil wire, or an encapsulated radioactive isotope; in some such embodiments, the apparatus associated with the switch may simply use SONAR, RADAR, X-rays, a Geiger or a like detector system to determine the relative location of that worn device. Similarly, in some embodiments, biologically safe electromagnetic detection apparatus, including in some cases but not limited to radio waves, may be used to simply detect the location of a breathing, moving or otherwise non-stationary individual within the proximity of a switch and to turn off or regulate the switch absent the presence of such an individual within the prescribed distance for some period of time. Similarly, in some embodiments, means for monitoring the presence of an individual in some proximity to the switch may comprise an optical device such as a video camera, CCD, or active pixel sensor.

As detailed more fully in other pending applications, including but not limited to U.S. patent application Ser. No. 13/362,802, proximity detection offers a wide array of other possibilities. As one specific example, it is possible to ascertain when your children exceed a distance from a prescribed location and to trigger a notification and/or alarm accordingly. Likewise, as another specific example, it is possible to locate a bicycle or other vehicle comprising an RF transceiver module, and/or alert the police if it has been stolen. Similarly, according to an example of some embodiments of the invention, entering a restaurant wearing a smart band or ring may engage a switch which places your customary order for you on arrival. Along these same lines, according to an example of some embodiments of the instant invention it is possible to disable a vehicle's ignition starter if an RF transceiver affixed to your seatbelt buckle is not sufficiently proximate to another RF transceiver core attached to the belt locking mechanism. As yet another specific example, proximity to other users may trigger an event, for example a basketball may be tossed when the two starting forwards in a basketball game first meet mid-court; as another example, a theatre proprietor may automatically deduct money from your account when you cross the entrance threshold; as yet another specific example of some embodiments, a bank ATM might permit you to withdraw funds upon detecting the proximity of your encoded ID.

Some embodiments of the invention comprise low voltage DC smart switches (e.g. for projects like garage door openers); some embodiments comprise light-duty AC smart switches (e.g. for small appliances like floor lamps, etc . . . ); some embodiments comprise heavy-duty AC smart switches (e.g. for large appliances). The classifications “light-duty” and “heavy-duty” recited above depend on power consumption of the associated devices and the corresponding current load each draws in use. In the context of this invention, every AC smart switch may be classified as either light-duty or heavy-duty or some combination of the two; likewise “low voltage” with respect to DC smart switches in the context of the instant invention typically refers to less than 50 volts at steady state but may be higher for transients (e.g. for DC motors at startup) and for certain other applications and instances. Some embodiments of the invention comprise switches triggered by proximity to and/or absence from a vicinity; some embodiments comprise switches actuated by a user directly, e.g. by a verbal command, button press, or gesture command; some embodiments comprise switches actuated by a user indirectly, for example by triggering on the air conditioning when a user enters a room that was too hot (e.g. as measured by a temperature sensor on a user's smart band or ring).

Some embodiments of the invention allow a user to regulate and/or control things like the temperature, the pressure or other manipulable physical attributes of an environment according to certain criterion, for example relative location in a physical environment. For example, smart bands and smart rings according to some embodiments of the invention comprise temperature sensors along with RF transceivers; when the local (user vicinity) temperature exceeds or falls below a prescribed or desirable (as determined e.g. by a user set rule or neural network algorithm) value, the air conditioning or heat is adjusted accordingly. In some embodiments, a smart band, ring or other device comprising a processing unit detects an event and triggers a switch and/or generates a signal to regulate something; in some embodiments a smart band or ring simply transmits sensor data to other hardware and software over a network—such a system may then actuate a heater or a blower or a switch or other element. In some embodiments, a smart band, ring or other device serves as an individual thermostat, and with some minor modifications to duct vents to put them under automated control, establishes an AC/heat solution that saves energy by only heating or cooling room(s) to satisfy one or more users(s) tastes. As one specific example, vents may be motorized with steppers, solenoids and/or servos which may be controlled over a wired and/or wireless home automation system. By closing vents not in use, it is possible to direct hot or cold air more efficiently to the targeted users; such control may be effectuated directly by a user, or indirectly as a function e.g. of a sensor trigger keyed to an individual. In some embodiments the motors controlling the vents may be controlled individually, permitting more than one user to attain localized or micro-climate control. More advanced systems may employ additional control vents inside ductwork and/or sophisticated control algorithms for anticipating and generating a user's desired environment.

In some embodiments, a switch, appliance, device or other apparatus may be set to not turn on until and unless the user physically actuates an element of a worn or carried device such as a bracelet or key-chain that may be physically connected to the user. For example, a user's electric range may be programmed to not turn on until the user first puts on and closes a bracelet about her wrist thereby switching on the power to the appliance.

In some embodiments of the invention, switches are not governed by a user directly, but instead by another device, for example a sensor module. Some examples of sensor modules according to some embodiments of the invention comprise sensors paired with RF transceivers so that they may perform both wireless sensing (i.e. wireless transmission of sensor data and information pertaining to and/or derived from sensor data) as well as actuation. That is, in some embodiments, sensor modules can be used to directly control switches, including but not limited to those regulating and/or governing appliances, devices and other apparatuses. In some embodiments, sensors, switches, smart bands and rings, and RF transceivers comprise modules that may be removably paired with one another. For example, in some embodiments a sensor module is paired with a wireless RF transceiver core and a switch with another wireless unit to permit remotely activated switches set by a sensor. In some embodiments, sensors may be paired with Bluetooth wireless RF cores set to provide continuous data stream to a cell phone, or PC, or to alert a user when a trigger threshold has been crossed.

Additional examples of sensor modules according to some embodiments of the invention include but are not limited to accelerometers, power usage monitors, pulse and heart rate monitors, optical sensors such as color and light sensors and imagers, motion sensors, humidity and pressure sensors, microphones and ultrasonic sensors, and user input devices for example bar code readers and cell phone touch screens.

In some embodiments, a smart ring comprises an RF transceiver core (e.g. which may comprise but is not limited to a Bluetooth, WiFi, or proprietary 2.4 GHz module), a microprocessor, a rechargeable battery (in some embodiments with charging circuitry), and an accelerometer for motion and gesture control. In some embodiments, smart bands, rings, switches and other devices may interact with more than one user, for example members of a family, or schoolchildren in a classroom.

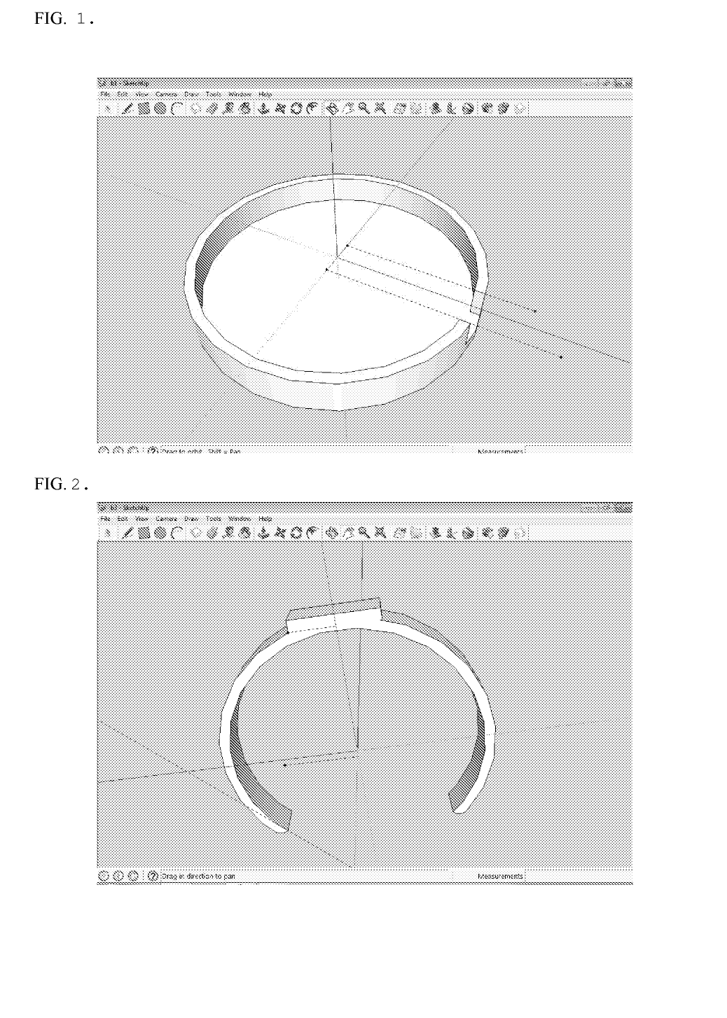

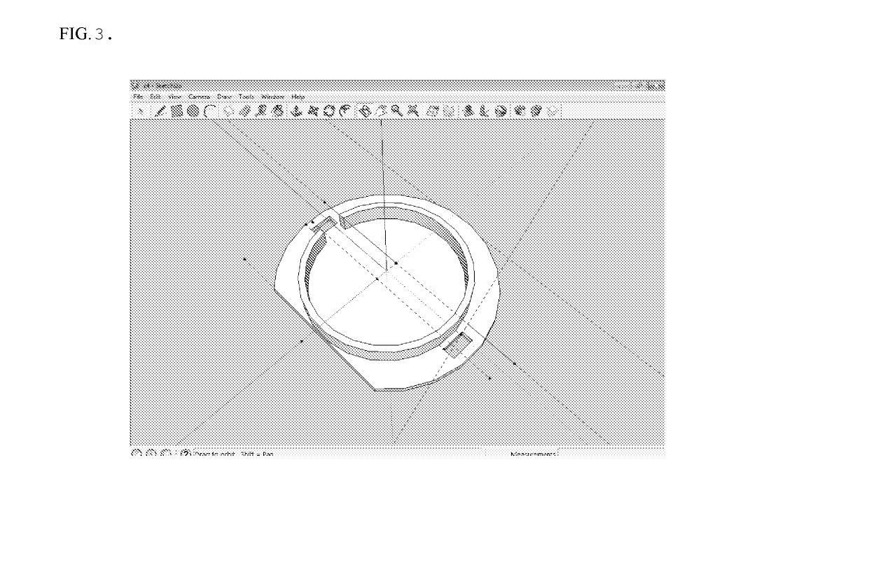

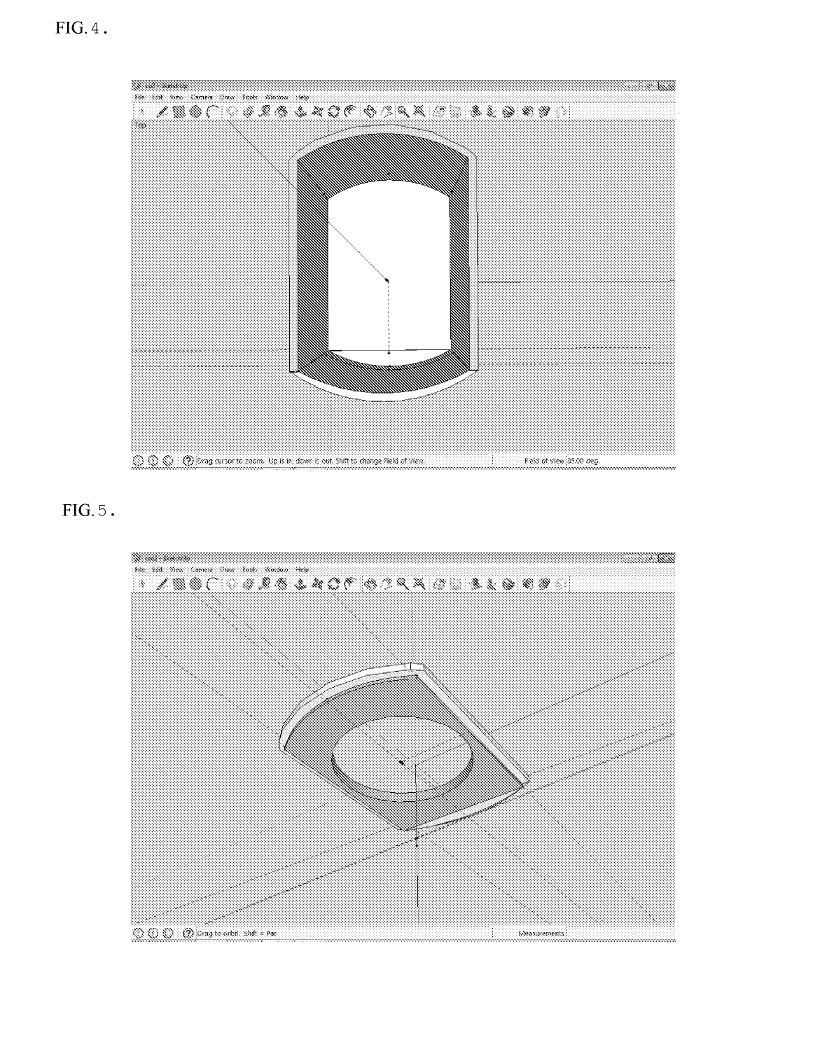

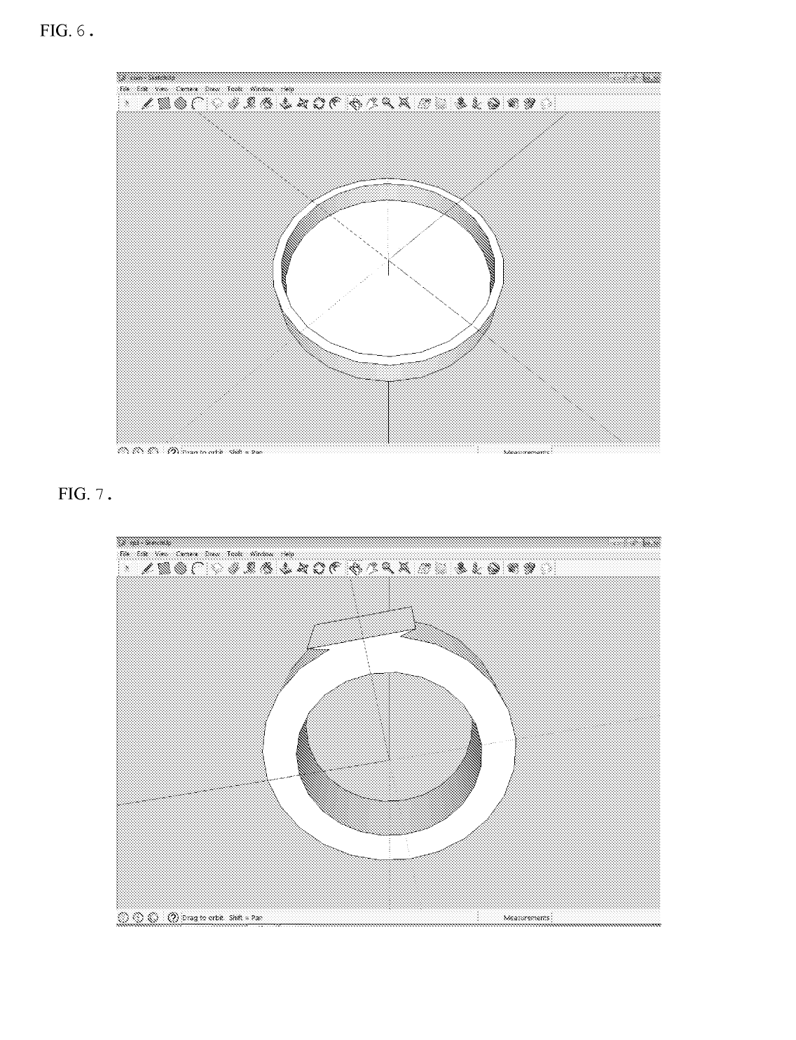

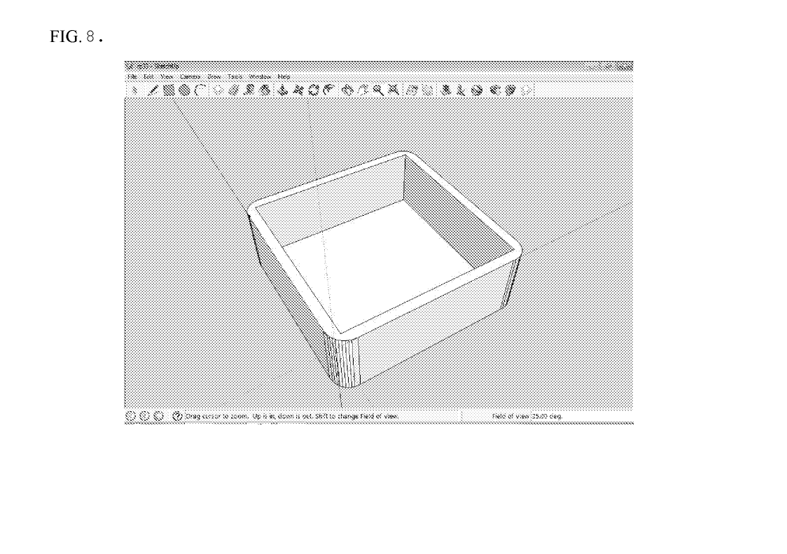

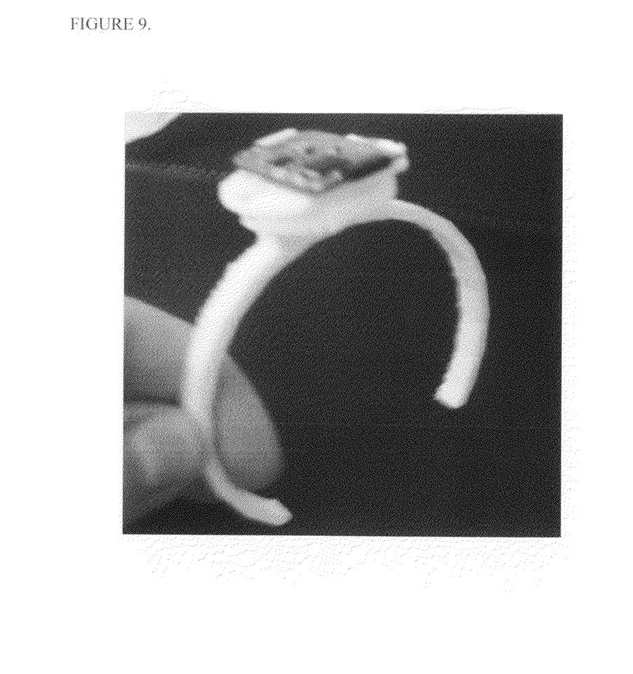

FIGS. 1-20 illustrate some examples of prototypes of embodiments of the instant invention. FIG. 1 illustrates a 3D schematic of an example of an element of an embodiment of a smart band for housing a power supply (a battery). FIG. 2 illustrates a 3D schematic of an example of another element of an embodiment of a smart band, comprising a rigid band onto which a mounting surface comprising a microcontroller, a communications module and a power supply may be affixed. FIG. 3 shows a 3D schematic of an example of another element of an embodiment of a smart band, comprising a cover for a power supply and a mounting surface for affixing a microcontroller and a communications module. FIGS. 4 and 5 respectively represent 3D schematics of an example of an embodiment of a housing and a housing cover for a sensor module. FIG. 6 illustrates a 3D schematic of an example of a mounting surface element of an embodiment of a smart ring, onto which a processing unit, a communications module and a power supply may be affixed. FIG. 7 illustrates a 3D schematic of an example of another element of an embodiment of a smart ring, comprising a rigid ring onto which a mounting surface comprising a communications module and a power supply may be affixed. FIG. 8 illustrates a 3D schematic of an example of a mounting surface element of an embodiment of a smart ring, onto which a processing unit, a communications module and a power supply may be affixed.

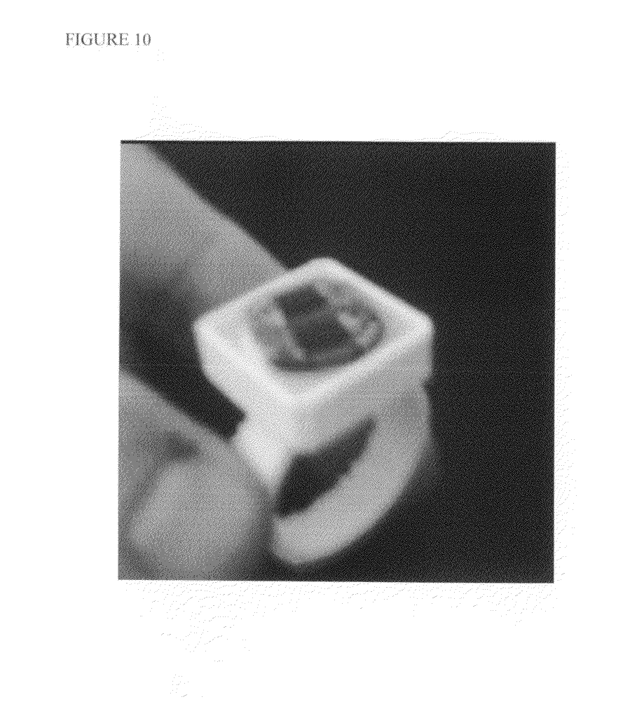

FIG. 9 illustrates an assembled example of a prototype of an embodiment of a smart band, comprising a rigid band onto which a mounting surface comprising a microcontroller, a communications module and a power supply is affixed. FIG. 10 illustrates an assembled example of a prototype of an embodiment of a smart ring, comprising a rigid band onto which a mounting surface comprising a pair of dummy circuits has been affixed. The specific prototype shown in FIG. 10 was prepared exclusively for sizing and dimensioning purposes.

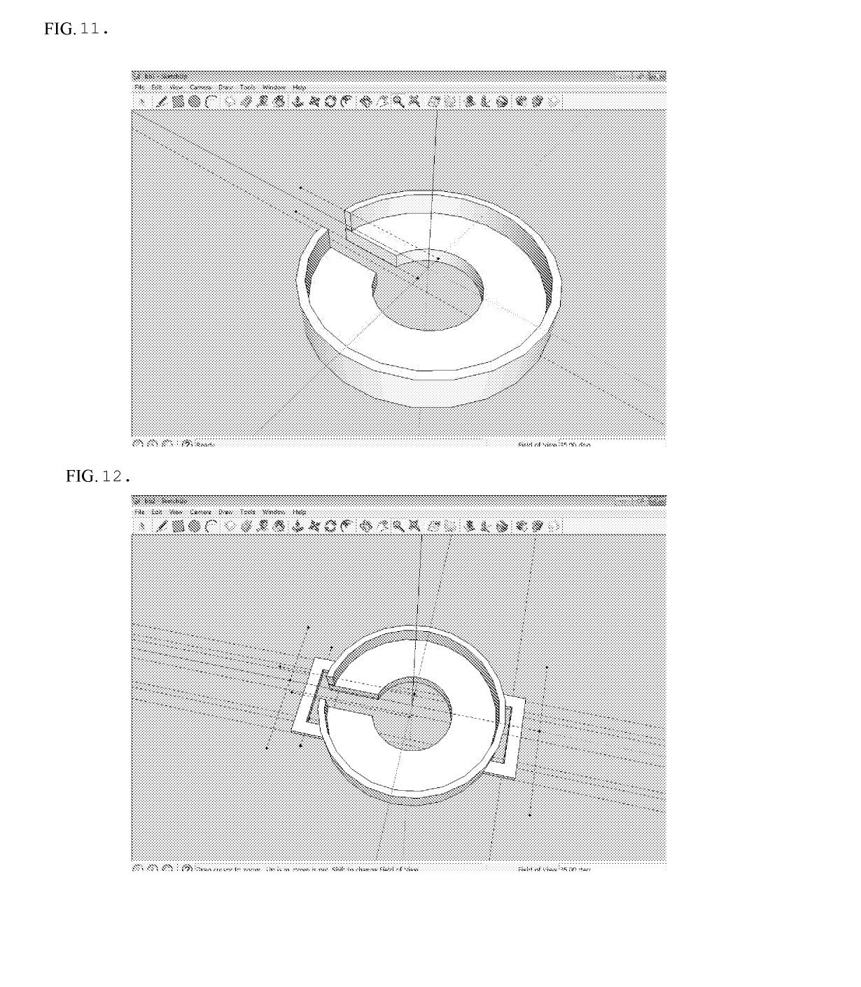

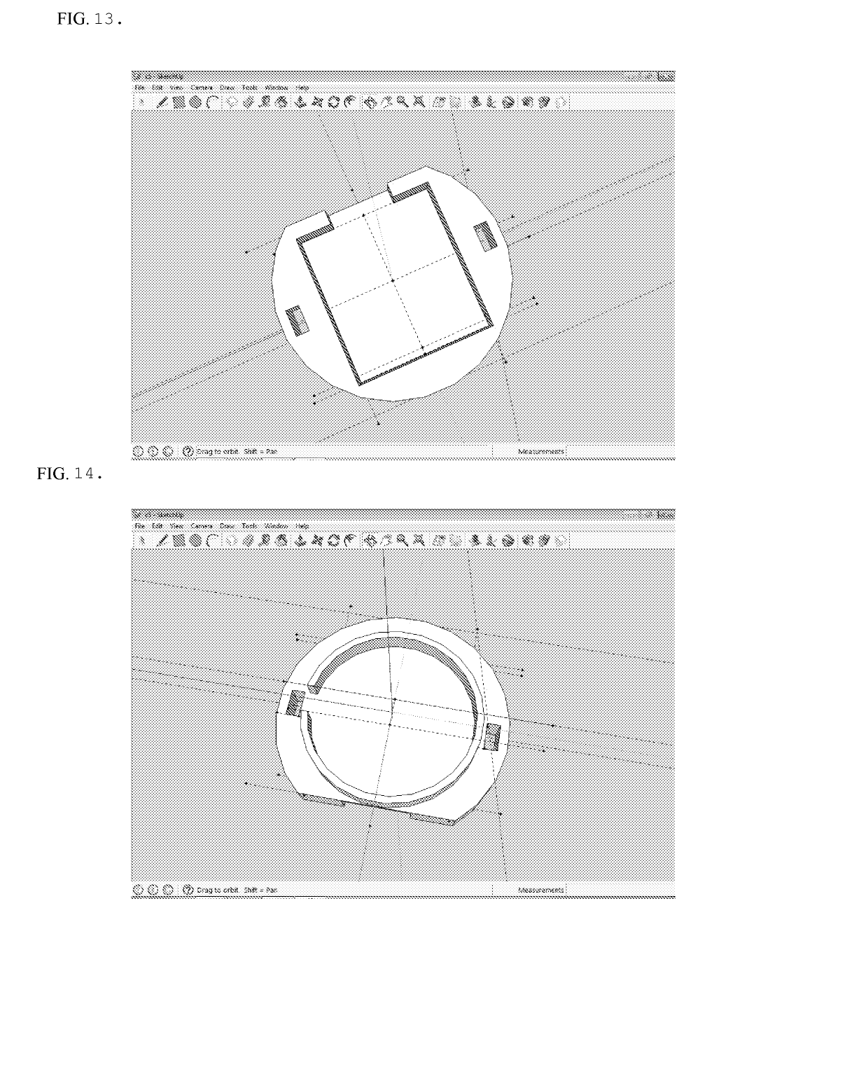

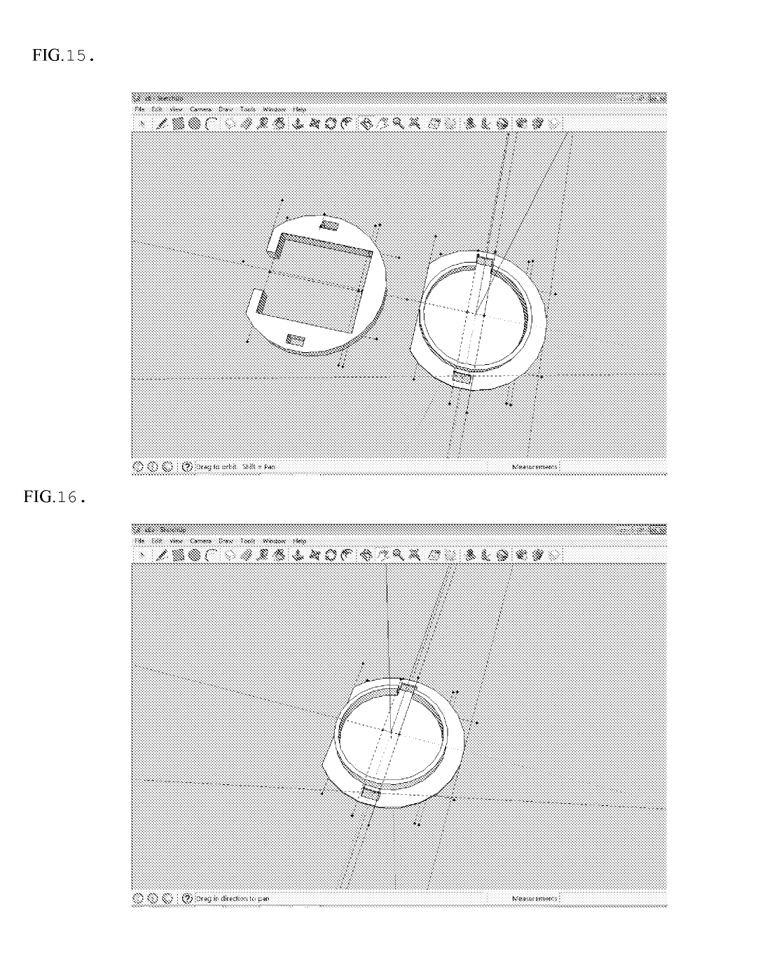

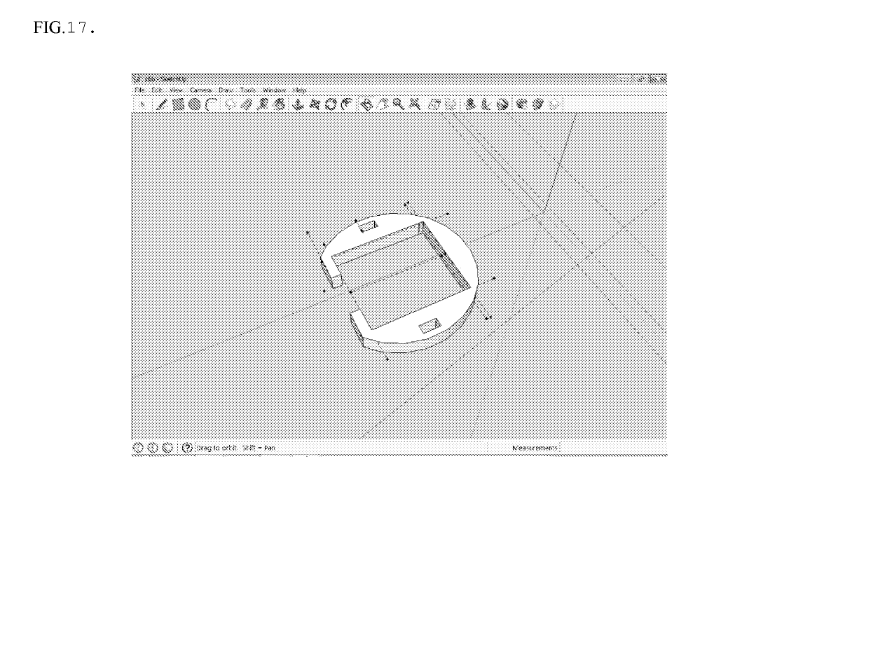

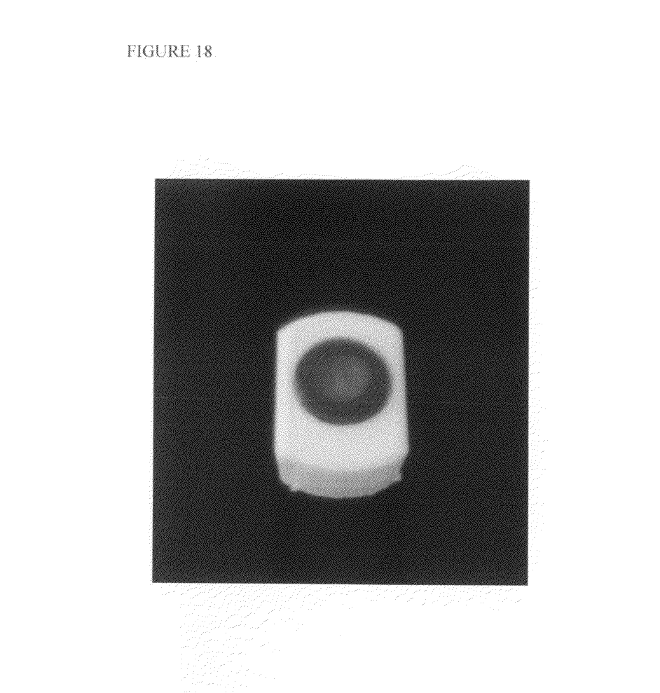

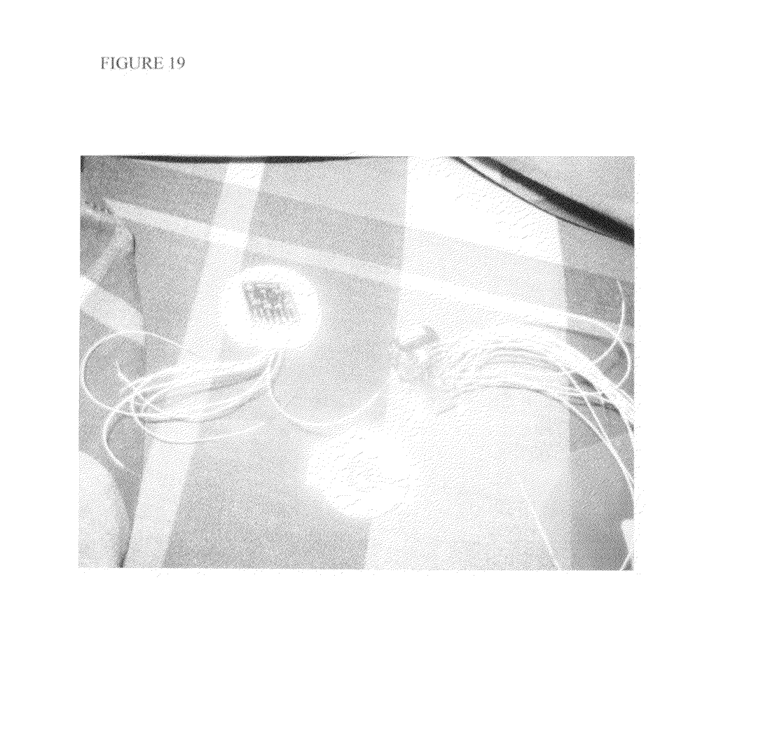

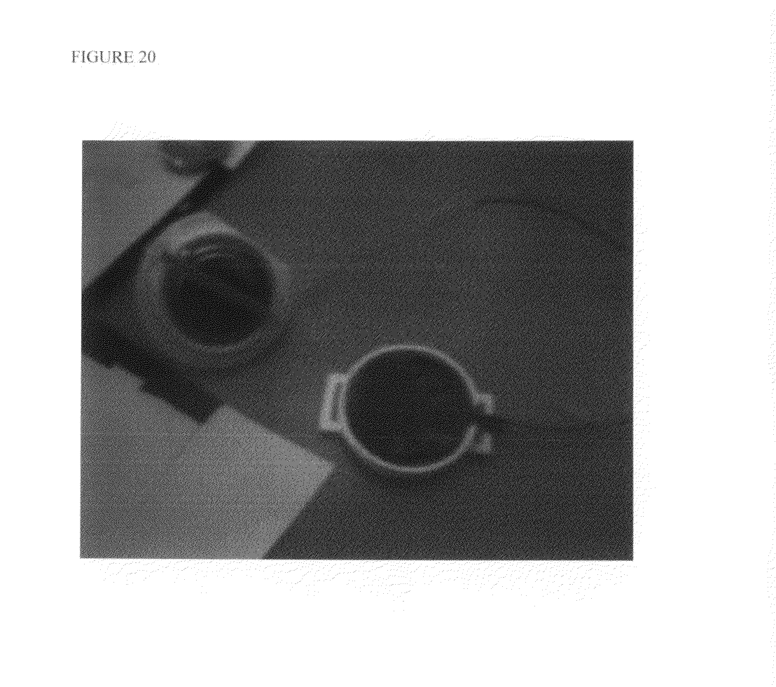

FIGS. 11-17 illustrates 3D schematics of the components comprising the housing of an example of an embodiment of a smart band. FIGS. 11 and 12 illustrate 3D schematics of two different examples of an element of an embodiment of a smart band, comprising a rigid base onto which a power supply and a mounting surface comprising a microcontroller, a communications module and an accelerometer may be affixed. In these Figures, the center slot is for an embedded vibrating transduction element; in FIG. 12, the square loops are designed to accommodate a flexible band, e.g. a watch band. FIGS. 13-17 illustrate 3D schematics of several different components of another element of an embodiment of a smart band, comprising mounting surfaces for a microcontroller, communications module, and accelerometer, and a cover for a power supply. FIGS. 13 and 14 illustrate respective views of a top and a bottom of a component of an embodiment, the top illustrated in FIG. 13 comprising a mounting surface and the bottom illustrated in FIG. 14 comprising a surface and a portion of a cover. FIG. 15 illustrates a view of two components of an embodiment, the left component in the figure comprising a mounting bracket and the right comprising a surface and a portion of a cover. FIG. 16 illustrates a component of an embodiment comprising a surface and a portion of a cover. FIG. 17 illustrates a component of an embodiment comprising a mounting bracket. FIG. 18 illustrates an assembled example of a prototype of an embodiment of a smart sensor, comprising a sensor module, a microcontroller and a housing. FIGS. 19-20 illustrate partially assembled examples of prototypes of embodiments of a smart device, comprising a rigid base, a microcontroller, a communications module, an accelerometer, a vibrating transduction element, and a power supply. Although the prototypes illustrated in the accompanying figures employ commercial-off-the-shelf circuit assemblies, some subsequent designs are custom fabricated.

In some embodiments of the invention, a smart device is a portable and/or wearable device comprising a communications module. In some embodiments a smart device may comprise a processing unit, a power supply and one or more means for generating and/or transmitting a signal. As a specific example of such an embodiment, a smart device may comprise a microcontroller, an RF communication module (e.g. Bluetooth or WiFi chip+antenna), rechargeable batteries, and a speaker. Communications between a smart device and another smart device, a computer, another device, a user, and/or a network may be by wired or wireless transmission means, although RF such as Bluetooth and WiFi are ubiquitous in cell phones and so provides an easy means of local wireless communication without the need for an individual seeking to use the system to purchase any additional hardware—he or she may simply download an app and then communicate accordingly

As a specific example of an embodiment of a smart device in action, a user enters a retail establishment while wearing or carrying a smart device and the retailer may automatically generate an instant coupon for the user upon entry. In some embodiments, a user of the instant invention may be a person; in some embodiments a user may be an agent, human or otherwise (e.g., a robot, a cell phone application, a hardware embedded algorithm, a clever chimpanzee, etc . . . ), capable of invoking or performing one or more of the methods and/or employing one or more of the means of embodiments of the instant invention.

In some embodiments, a smart device comprises an NFC tag and/or reader which may be brought in proximity to an NFC reader and/or tag to trigger an event; such an event might comprise an alert, e.g. via SMS, text message, e-mail, or other messaging protocol.

In some embodiments, events may be triggered and switches may be actuated by a simple threshold crossing or by any number of algorithms or formulas. Algorithms and/or formulas may be implemented by in hardware, software, by one or more human beings, by other entities (think chicken playing tic-tac-toe, or an AI generating optimal path), and/or by some combination of hardware, software and/or one or more human beings or entities. Adaptations and/or changes to formulas may be deterministic, stochastic, and/or determined by a neural network or AI, and may be a function of feedback which feedback may be generated or occur automatically, may be generated by a user, or otherwise.

Some embodiments of the invention comprise a global positioning system (“GPS”) device. Some embodiments of the invention comprise sensors including for example, optical sensing means such as an active pixel camera. In some embodiments, a smart device may comprise a cell phone and/or software. In some such embodiments, a cell phone may be used either independently or in conjunction with other hardware, software, and/or entities to locate entities, places and/or things. In some embodiments a smart device is in a vehicle. In some embodiments, a smart device comprises a cane. In some embodiments a smart device comprises crutches and in some embodiments a smart device comprises a walker. In some embodiments, a smart device comprises a pair of shoes, including all forms of footwear. In some embodiments a smart device comprises other clothing. In some embodiments a smart device comprises other hardware, including for example but not limited to an iPad, a tablet PC, an other computer, and/or a network of hardware and/or software.

In addition, in some embodiments, a device comprising software and/or hardware may be programmed and/or built to periodically poll, ping, survey or otherwise communicate with other devices, with sensors, with a network server, with a local hot spot, with markers, with beacons, and/or with other software and/or hardware in a vicinity. There are many other ways in which some embodiments of the invention may be realized, including but not limited to computer hardware devices which can communicate with entities possessing or fitted with compatible devices via RF, IR, or other electromagnetic or optical or sonic transceivers, or networked devices such as smart cell phones communicating on a dedicated frequency band or bands, or through the internet.

In some embodiments of the invention, processing units comprise microcontrollers. In some embodiments, a processing unit may comprise one or more of a display driver, speaker drivers, input channels, power conditioning circuits, memory, and power supply regulation circuitry. In some embodiments, a processing unit may comprise additional hardware and/or software for performing other functions including but not limited to processing and transmitting data, processing and transmitting power, storing and retrieving data, receiving and decoding voice commands, generating signals including but not limited to text, graphics, and speech, as well as for such miscellaneous functions as, e.g. waking and sleeping. In some embodiments, a processing unit comprises custom integrated circuits; in some embodiments the processing unit comprises discrete circuits. In some embodiments, a processing unit comprises a combination of hardware and/or software.

In some embodiments of the invention, a processing unit comprises a communications module—for example, a transceiver with antenna for communicating with other circuits, components, devices, systems, networks and individuals. In some embodiments, a communications module may be used to transmit and receive data such as, e.g. a signal from an RF transmitter, digital GPS coordinates, sensor data, firmware and software updates, as well as other data (e.g., the time and date, weather conditions, etc . . . ). In some embodiments, a communications module may comprise an antenna and/or coil for transmitting and/or receiving EM signals. A communications module may be integrated with the processing unit and/or comprise a separate component that may in some embodiments communicate with the processing unit. A communications module may communicate wirelessly along one or more wavelengths of the electromagnetic spectrum, including but not limited to, radio waves, IR, and visible light (e.g. via radio transceiver, IR transceiver, other coded and/or modulated light transmissions, etc . . . ). It may also communicate via wires, for example using one of a variety of USB cables. In addition, a communications module may include speakers and/or microphones and associated circuits for receiving and decoding voice commands and for generating sounds, including but not limited to speech. A communications module may also be integrated with the power supply—for example by capturing, harvesting and/or storing ambient or transmitted energy from an EM signal. A communications module may, in some embodiments, comprise an RF transceiver core.

Some embodiments comprise means for communicating information to a user. For example, some embodiments comprise means for producing vibration and/or low frequency compression waves, such as vibrating motors. Some embodiments comprise one or more lights, including but not limited to arrays of lights such as an LCD or LED display. For example, some embodiments comprise OLED (organic light emitting diode) screens like those found in modern cell phones and tablet PCs. However, as used in the context of this invention, displays are not intended to be limited to a single or even to existing technology—additional examples of displays comprise, but are not limited to, the following: liquid crystals, thin film transistors, incandescent lights, fluorescent lights, halogen lights, light emitting diodes, organic light emitting diodes, lasers, fiber optics, color-changing polymers, pigmented fluids, solutions and mixtures, functionalized micro-beads, and e-inks.

In some embodiments, a smart device may operate in conjunction with and/or be capable of transmitting data to and/or receiving data from an external device, system, or network using wires and/or wireless transmission methods. Illustrative examples of external devices comprise, but are not limited to, home alarms, cell phones, tablet computers, PDAs, e-readers (e.g. Kindle™ and Nook™), hearing aids, laptop and desktop computers, monitors and displays, televisions, calculators, iPods™ and MP3 players, radios and stereos, watches with electrical circuits, remote controls, bar code readers, keyboards, cameras, other input devices, data acquisition systems, other electrical devices comprising, e.g., microcontrollers, programmable interface controllers, digital signal processors, memories, field programmable gate arrays, discrete circuits, and other electrical circuits and hardware, including custom application specific integrated circuits (ASIC). In some embodiments of the instant invention, portions of residences and/or commercial establishments having appropriate circuitry (e.g. microcontrollers, DSPs, transceiver modules, input devices, etc . . . ) may comprise external devices and/or systems as defined herein. In addition, the world-wide-web, the Verizon™ wireless 4G LTE™ cellular network, and LANs are three illustrative examples of networks.

A smart device and/or tag according to some embodiments of the instant invention may obtain data via wireless transmission between hardware (e.g. sensors, or an onboard microcontroller, or other processor) external to the device and a transmitter and/or receiver in the device. Another method by which the smart device may obtain data is via wires (which may be metal or other conductive material, such as polymer), having uninsulated portions contacted to one or more surfaces of the smart device and which may be contacted to conductive surfaces or other wires. Rechargeable batteries may be charged by a number of means including but not limited to wirelessly by harvesting EM signals and via wires.

A smart device may comprise software and/or hardware—for example including but not limited to a system comprising a cellular phone running an application (“app”) comprises a smart device according to some embodiments of the instant invention.

In some embodiments, the process of interacting with, controlling and/or regulating something comprises one or more of the following steps: detecting, measuring, recording, receiving, collecting, and/or retrieving data; searching data; detecting a signal and/or an event; registering the existence of condition or event; classifying data; analyzing data; sorting data; estimating likelihoods; manipulating data; processing data; storing data; reading and/or writing data; transmitting and/or receiving data; binning data; reducing the dimensionality of data; discriminating data; comparing data; learning from data; recognizing patterns in data; predicting events based on data; as well as many other forms of analysis, manipulation and other processing of data; switching an appliance, device or other apparatus on or off; actuating an appliance, device or other apparatus; triggering an alert; generating a signal; transmitting a signal; vibrating a transducer; and controlling a display.

In some embodiments, data may be gathered and transmitted by devices possessed and/or employed by users and/or entities. As an example, a business owner might have an embedded image sensor in a storefront billboard that, in conjunction with other software and/or hardware, detects when preferred customers entered the premises, entering them into a queue automatically on recognition. Such data may be transmitted locally for example to other devices in range, to a local server, etc . . . and/or through the internet to one or more servers or other networked hardware and/or software.

In some embodiments, the invention may be practiced on a peer-to-peer network of smart and/or mobile devices, such as cell phones, smart phones, PDAs, netbooks, and/or other portable devices capable of wireless transmission and/or receipt of data. For example, a user may specify selected criteria to an application running on and/or embedded in the hardware of a device, and one or more such devices, in some embodiments in conjunction with additional hardware and/or software (e.g., PCs, smart billboards, savvy traffic lights with integrated transmitters and/or receivers, etc . . . ) may be used to practice some embodiments of the methods of the invention. As a more specific example, a traffic light according to some embodiments of the invention can interact with a smart device in a vehicle to apply the brakes if a user is a certain distance from a yellow light.

In some embodiments of the invention, data including but not limited to sensor updates may be transmitted to a smart device periodically. In some embodiments, data may be transmitted to a smart device on the occurrence of an event, such as a user pressing a button, starting a car, or turning a vehicle off and locking a home, an enclosure or a car.

In some embodiments of the instant invention, a user may transmit data to a smart device via an input means. Examples of input means for some embodiments of the instant invention include, but are not limited to, bar code readers and other optical input devices; real, touch and virtual keyboards; RFID tag detectors and/or decoders; radio, IR, visible light and/or other EM transmitters and/or receivers, microphones and decoding systems for spoken words, microphones and decoding systems for sound transmissions other than spoken words, optical sensors (including cameras and associated classification hardware and/or software), chemical sensors (e.g. to detect alcohol or other readily identifiable chemical compounds), as well as advanced scientific instruments (e.g. mass spectrometers, DNA sequencing instruments, NMR machines, etc . . . ). Input means may be a part of a smart device, may be physically and/or electrically attached to a smart device, and/or may be separate from a smart device.

It is possible to perform the steps of storing, processing, transmitting, receiving and/or displaying or otherwise outputting data or other information using a smart device in many ways. In some embodiments, one or more of the steps of switching and/or regulating appliances, devices and other apparatuses and/or of interacting with other users may be performed by some combination of software and/or hardware without human supervision or assistance. Some automated and other embodiments may require that a human user invoke the method in some fashion, e.g., by docking the smart device with a scheduling station, turning a device on, running an application, clicking a button or tapping a smart device, speaking a command, etc., and some automated and other embodiments may perform without a human user explicitly invoking the method. For example, a system could be programmed (in software and/or hardware) to begin operation upon the occurrence of some triggering event or events and/or the satisfaction of one or more conditions. In a more specific example, a smart phone application may be programmed to automatically cut the engine of a vehicle once a user arrives at a scheduled destination.

Other embodiments of the method may be partially automated, with some aspects of the method performed by software and/or hardware, and other aspects performed by or in conjunction with one or more individuals. As an example, a human user may enter criteria into a GUI on his smart phone which criteria are transmitted wirelessly according to a protocol to a system comprising software and/or hardware, such as a computer server running a program, that collects, monitors and/or analyzes data (e.g., criteria, locations, sensor readings, other data etc . . . ) from one or more users, entities and/or other sources, to tailor a hotel room's climate to an individuals' preferences and interest.

In addition, there are some embodiments where one or more of the steps of the invention may be performed by one or more individuals, using data obtained from, provided by and/or generated by hardware and/or software systems. Some embodiments in which the steps of the method are performed by one or more individuals may involve a service component, but such methods do not preclude the use of technology, for example, to act as gatekeepers. As a specific example of such an embodiment, a smart band might detect that a user was about to leave a residence while an oven remained on and suggest the user turn the appliance off; a user cooking a crockpot meal at low temperature over several hours might ignore the suggestion and disable the safety measure to leave the residence and go shopping. A remote operator could likewise perform the same functions at her discretion. As another specific example, a home sensor might transmit a text message alert to a user indicating that the temperature exceeded a threshold and requesting permission from the user to invoke the air conditioning. In such embodiments, although software and/or hardware might be used to perform one or more of the steps of the method of the invention, one or more human operators might also perform some of the steps.

In some embodiments of the invention, measured, ascertained and/or computed data may be transmitted and/or received by and/or retrieved by a smart device and/or other system comprising software and/or hardware. Such data may include, for example, but is not limited to: absolute location information, e.g. GPS coordinates; relative location information, e.g. grid coordinates; the distance or proximity between an entity, place or thing and a user and/or a device worn, carried by, or otherwise proximate to a user; the relative location of an entity, place or thing with respect to a user and/or to a device proximate to a user; the date; the time; environmental conditions such as weather, temperature, humidity and altitude; and other data relevant to some embodiments of the methods and means of the invention, Individual users and/or entities may elect to transmit or to have certain data concerning themselves transmitted to and/or retrieved by such a system. In some embodiments, a smart device and/or other system may ascertain data by one or more means including for example, but not limited to, measuring it, generating or observing it (e.g. pseudo-random numbers), retrieving it from memory, receiving it from users and/or entities via an input means, receiving it from external devices, software and/or hardware, including storage media; receiving it through a network such as the world-wide-web, retrieving it from publicly accessible or private disclosed records, extracting it from software and/or hardware employed by a user and/or entity, sensing it, and/or from any other accessible source. In addition, in some embodiments, a database or collection of data pertaining to users, things, entities and/or locations may be maintained (e.g., on the hard drives of a network server or other hardware), which could ease the computational and/or bandwidth load for the system so that only data which changed, e.g. user/entity/thing location, might be transmitted and/or detected on a repeated basis.

In some embodiments of the invention, transmission and receiving may be by an existing wireless digital protocol (see below), by a custom or future wireless protocol, by analog radio frequency or other EM spectrum (including but not limited to visible, IR, and UV light) transmission, by sound, or any other means of wireless transmission, or via wires, cables, and transferable storage media such as flash drives and data cards.

Various embodiments of the invention may be practiced in many ways, including for example, but not limited to, in real-time, continuously, periodically, regularly, on a schedule, at some prescribed intervals or times, with a given refresh and/or update rate, clocked, and/or asynchronously in an event-driven fashion. Event-driven broadly means triggered by or otherwise correlated in time or sequence with the occurrence of an event. Events include, but are not limited to, the detection of an entity, place and/or thing meeting certain criteria and/or satisfying certain conditions, the recognition that an entity, place and/or thing meets certain criteria and/or satisfies certain conditions, an entity crossing a threshold such as a boundary between a vicinity and an area outside that vicinity, the satisfaction of one or more environmental or other conditions, reaching a detected threshold value or level, the occurrence of something, a change in state, and other occurrences.

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A method for controlling and/or regulating things comprising the step of controlling and/or regulating something.

2. The method of claim 1 further comprising the steps of receiving data and controlling and/or regulating something in view of the received data.

3. The method of claim 2 further comprising the steps of evaluating the received data and controlling and/or regulating something based on the received data.

4. The method of claim 3 wherein the received data comprises one or more commands which alone and/or in concert with other data and/or in concert with instructions and/or rules invokes and/or dictates the manner of the controlling and/or regulating.

5. The method of claim 3 further comprising the steps of processing the received data to ascertain whether a condition is satisfied and/or an event has occurred and controlling and/or regulating something based on the satisfaction of a condition and/or the occurrence of an event.

6. The method of claim 1 wherein the step of controlling and/or regulating something is performed by a system comprising a smart switch.

7. The method of claim 1 wherein the step of controlling and/or regulating something is performed by a system comprising a smart device.

8. A smart device comprising hardware and/or software.

9. A smart switch comprising hardware and/or software.
